(19) United States
(12) Patent Application Publication
(10) Pub. No.: US 2025/0384344 A1
(43) Pub. Date: Dec. 18, 2025

(54) CONTINUOUS MACHINE LEARNING VALIDATION AND PERFORMANCE MONITORING

(71) Applicant: Optum, Inc., Minnetonka, MN (US)

(72) Inventors: Chandra Kalkere, Minneapolis, MN (US); Takumi Matsuzawa, Palo Alto, CA (US); Megan E Fenlon, Dublin (IE)

(21) Appl. No.: 19/236,065

(22) Filed: Jun. 12, 2025

Related U.S. Application Data
(60) Provisional application No. 63/660,110, filed on Jun. 14, 2024.

(51) Int. Cl. G06N 20/00

(52) U.S. Cl. CPC G06N 20/00

(57) ABSTRACT

Various embodiments of the present disclosure provide methods, apparatus, systems, computing devices, computing entities, and/or the like for maintaining performance of a predictive machine learning model by performing one or more out-of-sample tests using a rolling sample window based on availability of new production data, evaluating the out-of-sample tests based on one or more performance metrics for a decrease in performance of the predictive machine learning model, monitoring for differences between current production data and training data used to train the predictive machine learning model, and comparing output generated by the predictive machine learning model trained on a prior training dataset with output generated by the predictive machine learning model re-trained based on latest data.

### CROSS REFERENCE TO RELATED APPLICATION

This application claims the priority of U.S. Provisional Application No. 63/660,110, entitled “CONTINUOUS MACHINE LEARNING VALIDATION AND PERFORMANCE MONITORING,” filed on Jun. 14, 2024, the disclosure of which is hereby incorporated by reference in its entirety.

### BACKGROUND

Predictive machine learning models may be initially trained with training data to associate facts or data patterns with specific outcomes such that the predictive machine learning model may be used to generate predictions based on the association. Accuracy and performance of a predictive machine learning model may be dependent on the training data used to train the predictive machine learning model. In particular, the training data should have a similar distribution to data that the predictive machine learning model will be used on in a real-world setting. Various embodiments of the present disclosure address technical challenges related to maintaining a certain level of predictive machine learning model performance over time and provide solutions to address the shortcomings of existing predictive data analysis solutions.

### BRIEF DESCRIPTION OF THE DRAWINGS

FIG. 1 is a block diagram of an example architecture in accordance with some embodiments of the present disclosure.

FIG. 2 is a block diagram of an example predictive data analysis computing entity in accordance with some embodiments of the present disclosure.

FIG. 3 provides an example client computing entity in accordance with some embodiments of the present disclosure.

FIG. 4 is a flowchart diagram of an example process for performing predictive operations on production data in accordance with some embodiments of the present disclosure.

FIG. 5 is a flowchart diagram of an example process for maintaining a predictive machine learning model in accordance with some embodiments of the present disclosure.

FIG. 6 is an operational example of a confusion matrix in accordance with some embodiments discussed herein.

FIG. 7 is a flowchart diagram of an example process for generating training data in accordance with some embodiments of the present disclosure.

FIG. 8 is a flowchart diagram of an example process for training a Random Forest machine learning model in accordance with some embodiments of the present disclosure.

FIG. 9 is a flowchart diagram of an example process for simulating simulation prediction objects in accordance with some embodiments of the present disclosure.

FIG. 10 is a flowchart diagram of an example process for performing resource requests in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution is performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

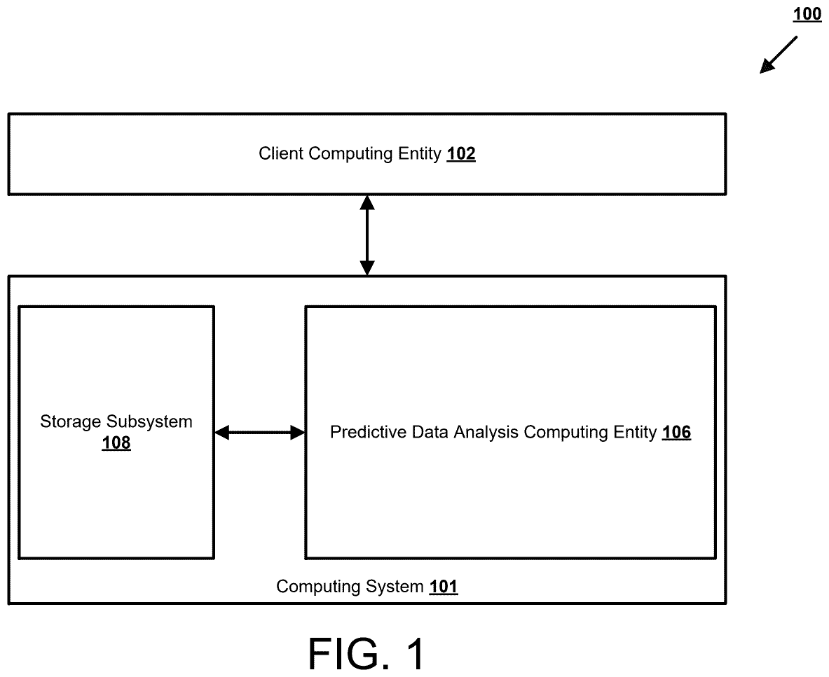

FIG. 1 is a block diagram of an example architecture 100 in accordance with some embodiments of the present disclosure. The architecture 100 comprises a computing system 101 configured to receive predictive data analysis requests from client computing entities 102, process the predictive data analysis requests to generate predictions, provide the generated predictions to the client computing entities 102, and automatically initiate performance of prediction-based actions based on the generated predictions. The example architecture 100 may be used in a plurality of domains and not limited to any specific application as disclosed herewith. The plurality of domains may include banking, healthcare, industrial, manufacturing, education, retail, to name a few.

In one example embodiment, the computing system 101 may receive requests to generate predictions on whether one or more resource-providing entities, if requested a resource at a specific time period, will or will not respond to the resource request within a target response time. The output of the computing system 101 may comprise a probability that a resource request will be responded to by the one or more resource-providing entities within the target response time. An example of a prediction-based action that can be performed using the computing system 101 comprises displaying a probability that a resource-providing entity will respond to the resource request within its target response time for a variety of resource sizes on a user interface. Other examples of prediction-based actions comprise generating a diagnostic report, displaying/providing resources, generating, and/or executing action scripts, generating alerts or reminders, or generating one or more electronic communications based on probabilities predicted by the predictive machine learning model.

According to various embodiments of the present disclosure, the computing system 101 may be configured to maintain performance of the predictive machine learning model over time by performing out-of-sample tests using a rolling sample window. As out-of-sample tests are performed, performance metrics may be evaluated for decreases in performance of the predictive machine learning model. Any sizable shift in the performance metrics may cause further analysis by computing system 101 to determine a root cause of the decrease in performance. Based on the root cause, the computing system 101 may re-train the predictive machine learning model with updated data from an extended training period. In doing so, the techniques described herein improve training and provide adaption of predictive machine learning models, trained based on historical data, to changing data trends. Accordingly, the techniques described herein improve the computational efficiency, storage-wise efficiency, and/or effectiveness of training predictive machine learning models.

In some embodiments, the computing system 101 communicates with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 comprises a predictive computing entity 106 and one or more external computing entities 108. The predictive computing entity 106 and/or one or more external computing entities 108 may be individually and/or collectively configured to receive predictive data analysis requests from one or more client computing entities 102, process the predictive data analysis requests to generate predictions corresponding to the predictive data analysis requests, provide the generated predictions to the client computing entities 102, and automatically initiate performance of prediction-based actions based on the generated predictions.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, up to each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the one or more external computing entities 108 may be configured to train, implement, use, update, and evaluate machine learning models in accordance with one or more training and/or inference operations of the present disclosure.

In some embodiments, the predictive computing entity 106 is configured to receive and/or transmit one or more datasets, objects, and/or the like from and/or to the one or more external computing entities 108 to perform one or more steps/operations of one or more techniques described herein. The external computing entities 108, for example, may comprise and/or be associated with one or more entities that may be configured to receive, transmit, store, manage, and/or facilitate datasets, and/or the like. The one or more external computing entities 108, for example, may comprise data sources that may provide such datasets, and/or the like to the predictive computing entity 106 which may leverage the datasets, such as production data, to perform one or more steps/operations of the present disclosure, as described herein. In some examples, the datasets may comprise an aggregation of data from across the one or more external computing entities 108 into one or more aggregated datasets. The one or more external computing entities 108, for example, may be associated with one or more data repositories, cloud platforms, compute nodes, organizations, and/or the like, which may be individually and/or collectively leveraged by the predictive computing entity 106 to obtain and/or aggregate data for an information domain.

In some embodiments, the predictive computing entity 106 is configured to receive a machine learning model that is trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Data Analysis Computing Entity

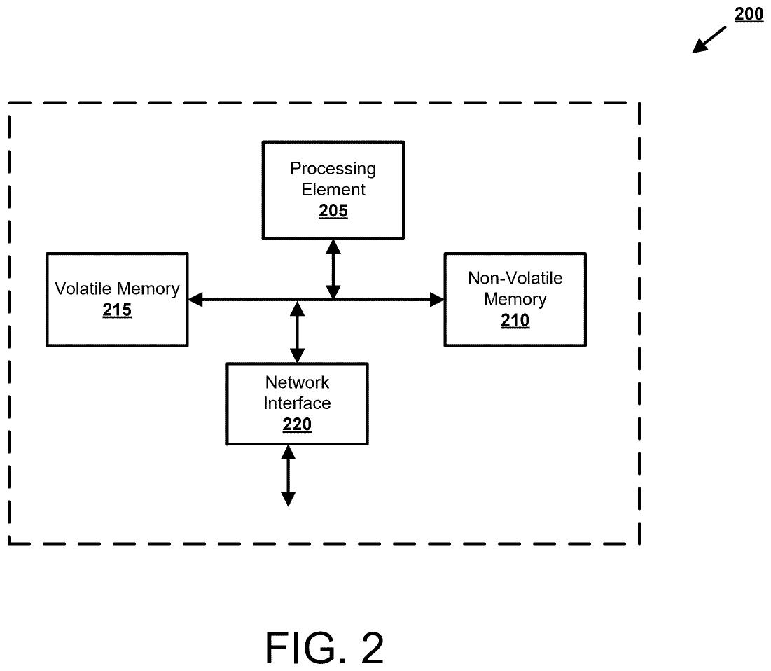

FIG. 2 is a block diagram of an example computing entity 200 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks,

FIG. 2 is a block diagram of an example computing entity 200 in accordance with some embodiments of the present disclosure. The computing entity 200 is an example of the predictive computing entity 106 and/or the one or more external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes are performed on data, content, information, and/or similar terms used herein interchangeably. In some embodiments, the one computing entity (e.g., predictive computing entity 106) trains and uses one or more machine learning models described herein. In other embodiments, a first computing entity (e.g., predictive computing entity 106, which may be one or more predictive computing entities) uses one or more machine learning models that may be trained by a second computing entity (e.g., the one or more external computing entities 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 comprises, or is in communication with, a processing element 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 further comprises, or is in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 comprises a computer-readable storage medium that may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 comprises a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilizes quantum bits, or qubits, which may exist in multiple states simultaneously through a property called superposition. Unlike classical bits that may only be in a state of 0 or 1, qubits may represent both states at once, allowing for exponentially greater quantities of information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing clement 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product is executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

In some embodiments, one or more components of the present disclosure are implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computing entity 200 may be specialized for machine learning tasks. By way of example, large language models (LLMs) and other transformer networks may be specially designed for operation within a quantum environment by replacing weight matrices in self-attention and/or multi-layer perceptron layers of such models with one or more combinations of variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 also comprises one or more network interfaces 220 for communicating with various computing entities (e.g., the client computing entities 102, the one or more external computing entities 108), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

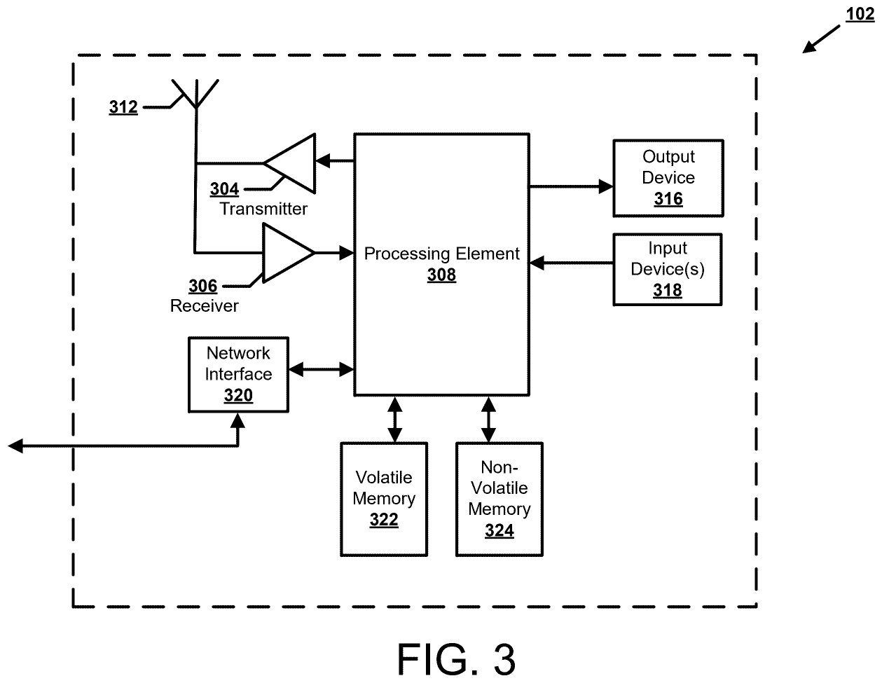

FIG. 3 is a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 comprises location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component acquires data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the one or more external computing entities 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 comprises one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 is embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity comprises one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. OVERVIEW

Various embodiments of the present disclosure make important technical contributions to improving predictive accuracy of predictive machine learning models by determining decreases in performance of a predictive machine learning model over time and adapting the predictive machine learning model based on a root cause of the decrease in performance. This approach prevents predictive machine learning model degradation and improves re-training efficiency of predictive machine learning models. It is well-understood in the relevant art that the performance of a predictive machine learning model decreases over time due to training using historical data, and as such, a predictive machine learning model performs best when the historical data patterns it is trained on are similar to current time period data patterns. Thus, the challenge is to improve maintaining a certain level of predictive machine learning model performance over time as new patterns emerge in input data without sacrificing the number of computational operations needed and/or the amount of training data entries needed to train predictive machine learning models. Accordingly, techniques that improve predictive accuracy by re-training on an as-needed basis, such as the techniques described herein, enable improving re-training efficiency given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

For example, various embodiments of the present disclosure improve predictive accuracy of predictive machine learning models by determining decreases in performance of a predictive machine learning model over time and adapting the predictive machine learning model based on a root cause of the decrease in performance. As described herein, a predictive machine learning model may not be as accurate when predicting a time period where the data and predictions on the data do not behave similarly to data patterns in the time period it was trained on. A predictive machine learning model may work best with regular patterns based on its training on historic data and utilization of the learnings from this historic data to infer a result on current data, and therefore the predictive machine learning model may need to be re-trained when new patterns in the data emerge.

However, in accordance with various embodiments of the present disclosure, a predictive machine learning model may be maintained over time by performing out-of-sample tests using a rolling sample window. As out-of-sample tests are performed, performance metrics may be evaluated for decreases in performance of the predictive machine learning model. Any sizable shift in the performance metrics may cause further analysis by a computing system to determine a root cause of the decrease in performance. Based on the root cause, the computing system may re-train the predictive machine learning model with updated data from an extended training period or based on synthetic data sets if actual historic data used for training does not represent expected future patterns. In doing so, the techniques described herein improve training and provide adaption of predictive machine learning models, trained based on historical data, to changing data trends. Accordingly, the techniques described herein improve the computational efficiency, storage-wise efficiency, and/or effectiveness of training predictive machine learning models.

### IV. EXAMPLE SYSTEM OPERATIONS

As indicated, various embodiments of the present disclosure make important technical contributions to improving predictive accuracy of predictive machine learning models by determining decreases in performance of a predictive machine learning model over time and adapting the predictive machine learning model based on a root cause of the decrease in performance. This approach prevents predictive machine learning model degradation and improves re-training efficiency of predictive machine learning models. It is well-understood in the relevant art that the performance of a predictive machine learning model decreases over time due to training using historical data, and as such, a predictive machine learning model performs best when the historical data patterns it is trained on are similar to current time period data patterns. Thus, the challenge is to improve maintaining a certain level of predictive machine learning model performance over time as new patterns emerge in input data without sacrificing the number of computational operations needed and/or the amount of training data entries needed to train predictive machine learning models. Accordingly, techniques that improve predictive accuracy by re-training on an as-needed basis, such as the techniques described herein, enable improving re-training efficiency given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

In some embodiments, a predictive machine learning model comprises a machine learning model that is configured to generate prediction outputs for one or more simulation prediction objects with respective one or more target resource-providing entities. According to various embodiments of the present disclosure, a predictive machine learning model is (i) trained on training data comprising one or more features associated with respective one or more resource-providing entities during a first time period and one or more one or more training simulation outcomes associated with respective one or more training simulation prediction objects, wherein (a) the one or more features comprise simulation outcome-affecting data and (b) the one or more training simulation outcomes are based on the simulation outcome-affecting data and (ii) trained to generate predictions for simulation prediction objects on one or more resource-providing entities based on production data during a second time period.

In some embodiments, a simulation prediction object represents a subject of prediction for a predictive machine learning model. According to various embodiments of the present disclosure, a simulation prediction object is representative of a potential plan of action with respect to a resource-providing entity of a cohort for given time instances occurring within a given historical time period. In some embodiments, a simulation prediction object is associated with a proposition, recommendation, or suggestion of a resource-providing entity. For example, a simulation prediction object may be representative of a resource request to a resource-providing entity. In some embodiments, a simulation prediction object comprises one or more parameters (e.g., resource size, target response time, and/or response rate) and a target outcome (e.g., response of resource request of a given resource size within a target response time).

In one example embodiment, a predictive machine learning model may be trained to evaluate response risk of resource-providing entities for a resource request. In the same example embodiment or in another example embodiment, a computing system may use a predictive machine learning model to evaluate one or more resource-providing entities by generating predictions on whether resource-providing entities, if requested a resource at a specific time period, will or will not respond to the resource request within a target response time. Output generated by the predictive machine learning model may comprise a probability that a potential resource request will be responded to within the target response time. For example, an output generated by the predictive machine learning model may comprise a number between ‘0’ and ‘1’ with ‘1’ being the highest probability that a resource-providing entity will respond to a resource request within a target response time and ‘0’ being the lowest probability that a resource-providing entity will respond to a resource request within the target response time. Accordingly, the output generated by the predictive machine learning model may be used to initiate the performance of one or more prediction-based actions.

In some embodiments, a predictive machine learning model comprises a Random Forest machine learning model. A Random Forest machine learning model may execute a Random Forest algorithm that takes input data (e.g., features from production data) and builds a series of independent decision trees. Each of the independent decision trees may then be averaged to determine a final prediction. In training, the Random Forest machine learning model may generate multiple decision trees by selecting randomly from a feature set (e.g., extracted from production data). This allows the Random Forest machine learning model to create many uncorrelated trees and thus reduces the opportunity for overfitting. The creation of multiple decision trees may also allow the Random Forest machine learning models to determine feature importance by evaluating which features have the most predictive power on a decision outcome. During the training of a Random Forest machine learning model, settings may be specified, such as settings to determine how many trees should be part of the Random Forest machine learning model, how many levels a tree should have, and what percent of a feature set should be captured in the random selection for any given tree. In some embodiments, the result of training a Random Forest comprises an optimized set of trees based on Gini Impurity.

The accuracy of a predictive machine learning model may decrease over time due to changing data patterns because, as often is the case, a predictive machine learning model is trained on historic data and utilizes the learnings from the historic data to infer a result on current data. As such, predictive machine learning models may require re-training when new patterns in model input data emerge. According to various embodiments of the present disclosure, as data patterns change, out-of-sample testing is performed on predictive machine learning models to determine, for example, when performance begins to degrade after a training period, and when the model should be re-trained on a more recent data set. In some embodiments, input data (e.g., taken from production data) is monitored for any change in patterns that may require re-training of the predictive machine learning model. For example, external factors may cause permanent changes to future input data such that model re-training may be necessary. In some embodiments, one or more predictive machine learning model parameters or training and/or test simulation prediction objects are varied based on a type and severity of impact of the external factors.

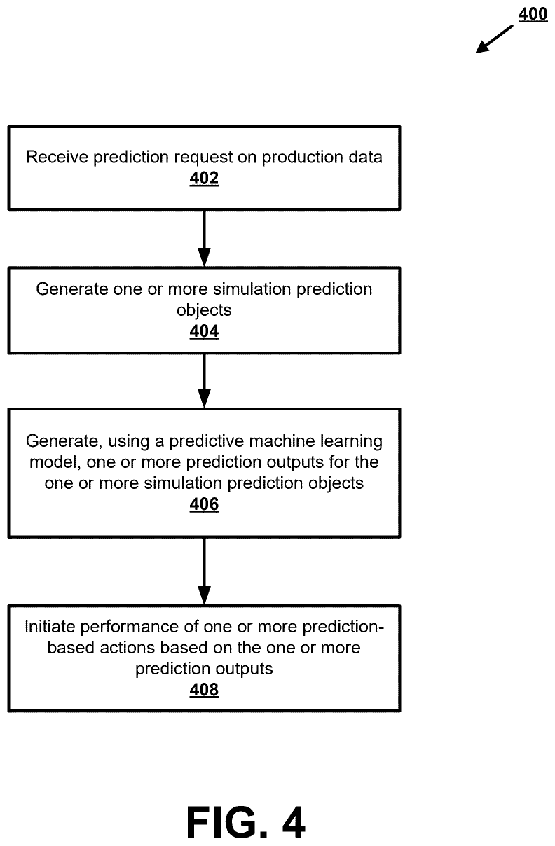

FIG. 4 is a flowchart diagram of an example process 400 for performing predictive operations on production data. In some embodiments, via the various steps/operations of the process 400, the computing system 101 uses a predictive machine learning model to generate and assign simulation prediction objects to resource-providing entities belonging to a target cohort and generate predictions for one or more simulation prediction objects associated with the one or more resource-providing entities.

FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence.

In some embodiments, at step/operation 402, the computing system 101 receives a prediction request on production data. The prediction request may comprise a request to evaluate production data associated with one or more resource-providing entities from a given cohort. In some embodiments, the request comprises one or more criteria, such as criteria associated with the given cohort. In some embodiments, prediction requests are received from client computing entities 102, or received as an instruction from automated software or script that is executed periodically, e.g., each month. In an example embodiment, the prediction request on production data may comprise a request to run a predictive machine learning model on a population of resource-providing entities with an intention to make a prediction on whether each resource-providing entity, if requested a resource at a specific time period, will or will not respond to the resource request within its target response time. The prediction generated by the predictive machine learning model may be used to identify a cohort of resource-providing entities that meet a request-response metric to be further evaluated for requesting a resource therefrom.

In some embodiments, production data comprises data that is collected, transformed, and provided as input to and/or used to train and/or test a predictive machine learning model. Production data may comprise one or more features, associated with one or more resource-providing entities of a cohort, which are usable by a predictive machine learning model to learn and generate predictions on simulation prediction objects. According to an example embodiment, production data may comprise data, such as task performance history, which may be analyzed by a predictive machine learning model configured to predict a probability of a resource-providing entity responding to a resource request of a given size within a given response time.

In some embodiments, at step/operation 404, the computing system 101 generates one or more simulation prediction objects for respective one or more resource-providing entities. A simulation prediction object may comprise a subject of prediction for a predictive machine learning model. For example, a simulation prediction object may be representative of a resource request to a resource-providing entity. In some embodiments, a simulation prediction object comprises one or more parameters (e.g., resource size, target response time, and/or response rate) and a target outcome (e.g., response of resource of a given resource size within a target response time and/or response rate).

In some embodiments, at step/operation 406, the computing system 101 generates, using a predictive machine learning model, one or more prediction outputs for the one or more simulation prediction objects. Generating the one or more prediction outputs may be representative of predicting outcomes for simulated conditions (e.g., a simulated resource request). The one or more prediction outputs may be generated based on one or more features associated with respective ones of the one or more resource-providing entities. In some embodiments, generating the one or more prediction outputs comprises extracting the one or more features from the production data.

In some embodiments, a feature comprises an attribute or characteristic of data that may be analyzed by a predictive machine learning model to generate prediction outputs. For example, features and expected outcomes may be provided in training data (which may be based on at least a portion of production data) and used to train a predictive machine learning model, thereby forming associations between features and certain outcomes (e.g., a target outcome for one or more simulation prediction objects). Features may also be extracted from production data and provided as input to the trained predictive machine learning model to generate prediction outputs. As such, a predictive machine learning model may be trained to determine one or more effects of respective one or more features and generate prediction outputs based on the determined effects.

In some examples, features extracted from production data comprise simulation outcome-affecting data, which may be used to determine simulation outcomes associated with simulation prediction objects. According to various embodiments of the present disclosure, a predictive machine learning model is trained on one or more features and one or more training simulation outcomes to generate prediction outputs.

In one example embodiment, production data may comprise one or more features associated with task performance history which may be used by the predictive machine learning model to determine a resource (a simulation prediction object) amount (e.g., resource amount based on expectation of future task performances) and predict a response to a resource request (a prediction output).

In some embodiments, a set of features are selected for constructing a predictive machine learning model by evaluating which features have the most predictive power on a prediction outcome. In some embodiments, a series of decision trees are generated via a Random Forest algorithm by selecting randomly from a plurality of features. The series of decision trees generated by the Random Forest algorithm may comprise individual, uncorrelated decision trees which may prevent overfitting. At each node of the decision trees, a decision may be made by evaluating a feature value against a threshold. Finding the best feature/threshold combination at each node may be performed by minimizing the Gini Impurity. The Gini Impurity may comprise a measure of how often a randomly chosen observation from a set would be incorrectly classified if it was randomly classified using a feature/threshold combination. A set of features with the lowest Gini Impurity may result in a lower probability of misclassification and therefore may be the most desirable to use by a predictive machine learning model. In some embodiments, a feature set is judged based on performance metrics to evaluate how well a model trained using the features performs based on a set of test simulation outcomes associated with one or more test simulation prediction objects.

In some embodiments, a predictive machine learning model is (i) trained on training data comprising one or more features associated with a plurality of resource-providing entities during a first time period and one or more training simulation outcomes associated with respective one or more training simulation prediction objects, wherein (a) the one or more features comprise simulation outcome-affecting data and (b) the one or more training simulation outcomes are based on the simulation outcome-affecting data and (ii) trained to generate predictions for non-training simulation prediction objects using input data based on production data during a second time period.

In some embodiments, a simulation outcome comprises an outcome simulated for a simulation prediction object based on simulation outcome-affecting data. A simulation prediction object may be representative of a potential plan of action that has not actually materialized, and as such, an actual outcome of the simulation prediction object may not exist. According to various embodiments of the present disclose, a predictive machine learning model is trained to predict outcomes of simulation prediction objects based on training simulation outcomes generated for training simulation prediction objects based on simulation outcome-affecting data extracted from production data. As such, a simulation outcome may be representative and used in place of an actual outcome (or classification label) for training a predictive machine learning model. For example, a training simulation prediction object may be representative of a resource request to a resource-providing entity, and a training simulation outcome may comprise a simulation of a resource request and simulated response of the simulated resource request by the resource-providing entity based on simulation outcome-affecting data comprising task performance by the resource-providing entity (e.g., that may be used to respond to the simulated resource request). Simulation outcomes may also be used for performing in-sample tests and/or out-of-sample tests by comparing simulation outcomes with prediction output generated by a trained predictive machine learning model.

In some embodiments, simulation outcome-affecting data comprises data that is extracted from production data to generate a simulation outcome of a simulation prediction object. For example, simulation outcome-affecting data for a simulation outcome comprising response of a simulated resource request (simulation prediction object) by a resource-providing entity may comprise actual historic task performances received by the resource-providing entity. In one example embodiment, simulation outcome-affecting data may comprise actual historic task performances over the historical period and simulation outcomes may comprise simulated response of the simulated resource requests based on the actual historic task performances. During training, the predictive machine learning model may observe training simulation outcomes for training simulation predictions objects, e.g., whether resource requests were responded to within the target response time or outside the target response time based on the simulated responses. When trained, for each resource-providing entity, the predictive machine learning model may generate as a prediction output, a probability that a resource request for various resource sizes will be responded to within a target response time.

In some embodiments, at step/operation 408, the computing system 101 initiates performance of one or more prediction-based actions based on the one or more prediction outputs. Initiating the performance of the one or more prediction-based actions based on the one or more prediction outputs comprises, for example, performing a resource-based action (e.g., via an allocation of resource), generating an analytical report, generating and/or executing action scripts, generating alerts or messages, or generating one or more electronic communications. The one or more prediction-based actions may further include displaying visual renderings of the aforementioned examples of prediction-based actions in addition to values, charts, and representations associated with the one or more prediction outputs using a prediction output user interface.

According to various embodiments of the present disclosure, performance monitoring of a predictive machine learning model is performed to maintain predictive ability and accuracy over time. In particular, a predictive machine learning model may be only as effective as the data it was trained on (e.g., quality and variety of training data). As such, a predictive machine learning model may not be able to predict on data patterns it has not seen before during training. A predictive machine learning model may perform best when historical data patterns it has been trained on are similar to data (e.g., of a current time period) that is provided to the predictive machine learning model for prediction. However, in real-world applications, features associated with trained prediction outputs may change over time causing predictions made by a predictive machine learning model to become less accurate as time passes. For example, training data may reflect conditions causing a given outcome that are more relevant in a given period than in subsequent periods where conditions for causing the same given outcome may have changed. Additionally, underlying features of training data the model was trained on may be materially different from prediction input data (e.g., taken from production data) the predictive machine learning model uses to generate predictions on. For example, a predictive machine learning model may be trained on a cohort of resource-providing entities that is constantly changing.

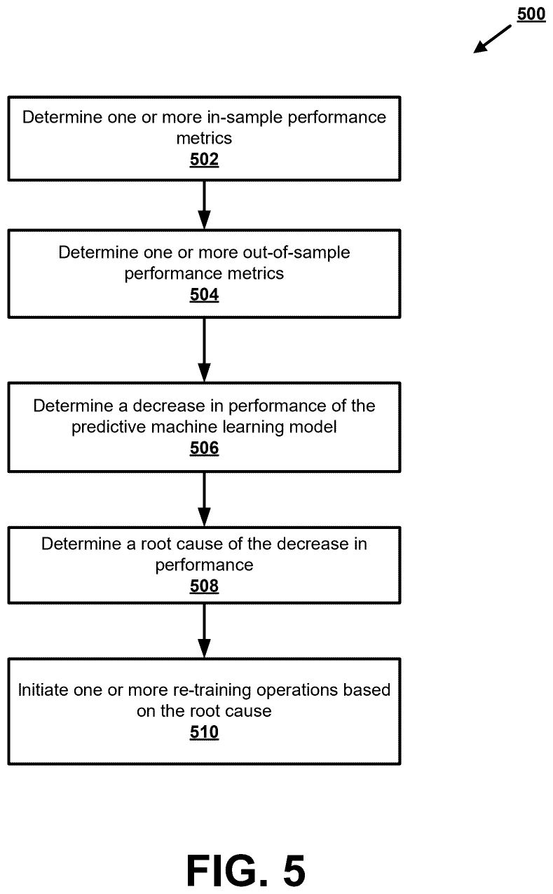

FIG. 5 is a flowchart diagram of an example process 500 for maintaining a predictive machine learning model. FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 begins at step/operation 502 when the computing system 101 determines one or more in-sample performance metrics for a predictive machine learning model based on an in-sample test on the predictive machine learning model. The in-sample test may be performed on the predictive machine learning model using one or more in-sample test simulation prediction objects associated with production data during an in-sample time period.

In some embodiments, an in-sample test comprises an evaluation of output generated by a predictive machine learning model based on input data (e.g., extracted from production data), associated with a same time period as training data, not evaluated by the predictive machine learning model during training to determine prediction accuracy of the predictive machine learning model. An in-sample test may be performed to determine if a trained predictive machine learning model can perform accurate predictions on data it has not yet seen. Performing an in-sample test may comprise simulating an actual outcome for each input so that a comparison to predictive machine learning model output can be made to determine performance of the predictive machine learning model. In some embodiments, performing an in-sample test comprises (i) generating one or more in-sample test simulation prediction objects for respective one or more resource-providing entities associated with a cohort during an in-sample time period, (ii) determining one or more in-sample feature values based on production data during the in-sample time period, (iii) generating, using the predictive machine learning model, one or more in-sample prediction outputs for the one or more in-sample test simulation prediction objects based on the one or more in-sample feature values, (iv) extracting simulation outcome-affecting data from the production data during the in-sample time period, (v) determining a set of in-sample test simulation outcomes associated with the one or more in-sample test simulation prediction objects based on the simulation outcome-affecting data, and (vi) determining one or more in-sample performance metrics based on a comparison between a determination of whether the set of in-sample test simulation outcomes comprises a target outcome for the one or more in-sample test simulation prediction objects and the one or more in-sample prediction outputs. In some embodiments, performing an in-sample test further comprises determining and evaluating one or more performance metrics of the predictive machine learning model.

In some embodiments, at step/operation 504, the computing system 101 determines one or more out-of-sample performance metrics for the predictive machine learning model based on one or more out-of-sample tests on the predictive machine learning model. The one or more out-of-sample tests may be performed on the predictive machine learning model using one or more out-of-sample test simulation prediction objects associated with production data during an out-of-sample time period. The out-of-sample time period may be subsequent to the in-sample time period (associated with the in-sample test). The out-of-sample time period may also comprise a rolling sample window based on availability of new production data.

In some embodiments, an out-of-sample test comprises an evaluation of output generated by a predictive machine learning model based on input data (e.g., extracted from production data), associated with a different time period than that of training data, not evaluated by the predictive machine learning model during training to determine prediction accuracy of the predictive machine learning model. An out-of-sample test may be performed to determine if a trained predictive machine learning model is capable of performing accurate predictions on data outside of the time period it was trained on. In some embodiments, performing an out-of-sample test comprises (i) generating one or more out-of-sample test simulation prediction objects for respective one or more resource-providing entities associated with a cohort during an out-of-sample time period, (ii) determining one or more out-of-sample feature values based on production data during the out-of-sample time period, (iii) generating, using the predictive machine learning model, one or more out-of-sample prediction outputs for the one or more out-of-sample test simulation prediction objects based on the one or more out-of-sample feature values, (iv) extracting simulation outcome-affecting data from the production data during the out-of-sample time period, (v) determining a set of out-of-sample test simulation outcomes associated with the one or more out-of-sample test simulation prediction objects based on the simulation outcome-affecting data, and (vi) determining one or more out-of-sample performance metrics based on a comparison between a determination of whether the set of out-of-sample test simulation outcomes comprises a target outcome for the one or more out-of-sample test simulation prediction objects and the one or more out-of-sample prediction outputs.

In some embodiments, a rolling sample window comprises a specific interval of time that shifts forward with the passage of time or periodicity of data. A rolling sample window may be used to define a selected dataset based on the availability of new production data. For example, a rolling sample window may be used to define production data for performing out-of-sample tests of a predictive machine learning model during time instances of a plurality of time periods subsequent to an in-sample time period (the in-sample time period coincident with a time period associated with training data used to train the predictive machine learning model) as new data is available to update production data.

In some embodiments, new production data comprises production data or a state of production comprising most up-to-date information. That is, new production data may comprise data that has been collected during a most recent time period. For example, production data comprising data associated with or collected during a second time period may be considered as new production data compared to production data associated with or collected during a first time period that precedes the second time period. In some embodiments, a rolling sample window for performing out-of-sample testing is based on an availability of new production data.

As described herein, in accordance with various embodiments of the present disclosure, a predictive machine learning model is maintained over time by performing out-of-sample tests using a rolling sample window. As out-of-sample tests are performed, performance metrics may be evaluated for decreases in performance of the predictive machine learning model. Any sizable shift in the performance metrics may cause further analysis by computing system 101 to determine a root cause of the decrease in performance. Based on the root cause, the computing system 101 may re-train the predictive machine learning model with updated data from an extended training period or representative synthetic data set. In doing so, the techniques described herein improve training and provide adaption of predictive machine learning models, trained based on historical data, to changing data trends. Accordingly, the techniques described herein improve the computational efficiency, storage-wise efficiency, and/or effectiveness of training predictive machine learning models.

In some embodiments, at step/operation 506, the computing system 101 determines a decrease in performance of the predictive machine learning model based on a comparison between the one or more in-sample performance metrics and the one or more out-of-sample performance metrics.

In some embodiments, a performance metric comprises a measurement of predictive machine learning model performance and effectiveness. One or more performance metrics may be obtained of a predictive machine learning model to evaluate fit and performance of the predictive machine learning model against its intended purpose. In some embodiments, a decrease in performance of a predictive machine learning model is determined by comparing one or more performance metrics determined from an in-sample test with one or more performance metrics determined from respective one or more out-of-sample tests. Examples of performance metrics may include, but are not limited to, recall/sensitivity, specificity, precision, accuracy, F1-score, and Shapley Additive Explanation (SHAP) values. Additionally, performance metrics of a predictive machine learning model may be obtained by generating a confusion matrix, a receiver operator characteristic (ROC) curve, or a precision/recall (PR) curve.

Recall/sensitivity may comprise true positive rate representative of what proportion of actual positives were predicted correctly. The value of recall/sensitivity may be high and may remain high as a predictive machine learning model accurately predicts an actual outcome. The precision of a predictive machine learning model may be representative of a percent of predictions that were correct. Precision may decrease over time driven by increases in false positives. This shift over time can also be seen in the reduction of specificity. Specificity may be representative of a percent of actual negatives were predicted correctly. Low specificity may not be an immediate cause for concern on the performance of a predictive machine learning model of the predictive machine learning model maintains good precision. A decrease in specificity and precision between in- and out-of-sample periods may also cause decreases in area under the curve for ROC and PR, respectively.

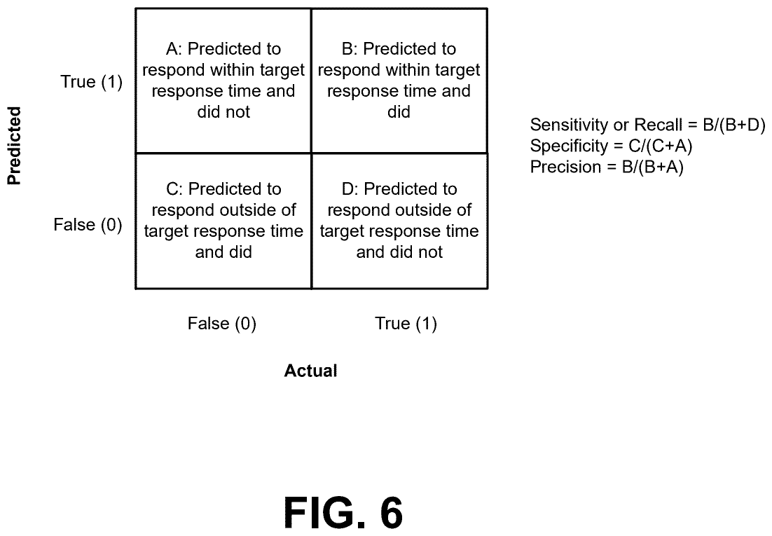

In some embodiments, confusion matrices provide valuable information that are used to evaluate the fit and performance of a predictive machine learning model against its intended purpose by showing the intersection of model predictions and actual classifications. As depicted in FIG. 6, a confusion matrix comprises four quadrants—true positives, true negatives, false positives, and false negatives. A true positive may represent a correct positive prediction (e.g., B—predict that a resource request will be responded to within a target response time and did). A true negative may represent a correct negative prediction (e.g., C—predict that a resource request will be responded to outside of a target response time and did). A false positive may represent an incorrect positive prediction (e.g., A—predict that a resource request will be responded to within a target response time when it actually responded outside of the target response time). A false negative may represent an incorrect negative prediction (e.g., D—predict that a resource request will be responded to outside of a target response time when it actually responded to within the target response time). Confusion matrices may be used to evaluate the performance of a predictive machine learning model and to compare performance across predictive machine learning models when developing, training, testing and monitoring. Performance metrics (sensitivity, specificity, precision and recall) may comprise values that are calculated from data in a confusion matrix. Confusion matrices may comprise raw numbers in each quadrant or percentages of the total actual classification population evaluated. Confusion matrices may also represent the results of a population at a single discrimination threshold. A discrimination threshold may refer to a threshold that represents when an observation should be labeled as ‘true’ in a binary classification model. A prediction score equal to or above the threshold may be categorized as ‘true’. For example, predicted probability of 0.4 may be considered ‘false’ if the threshold is 0.5, but would be considered ‘true’ if the threshold is 0.3. A ‘true’ classification, for example, may represent a prediction that a resource request will be responded to within a target response time.

An ROC curve may comprise a graphical plot that illustrates the performance of a predictive machine learning model as its discrimination threshold is varied. An ROC curve may plot a predictive machine learning model's true positive rate against a true negative rate at each threshold.

The y-axis of an ROC curve may represent sensitivity, or true positive rate, which may be defined as:

$$Sensitivity = \frac{number of true positives}{number of true positive + number of false negatives} \qquad \underline{Equation 1}$$

The x-axis of an ROC curve may represent specificity, or true negative rate, which may be defined as:

$$Specificity = \frac{number of true negatives}{number of true negatives + number of false positives} \qquad \underline{Equation 2}$$

An ROC curve graph may be used to visually compare many different predictive machine learning models. Predictive machine learning models with curves higher and to the left may generally have better performance. The area under the curve (AUC) of an ROC curve may be used to compare different models.

An ROC AUC may provide a measure of relationship between sensitivity and specificity. The greater the ROC AUC, the better the performance of a predictive machine learning model may be. ROC curves may be used to compare the performance of different feature sets. ROC curves may also be useful when evaluating the performance of predictive machine learning models that use different assumptions for training and testing. For example, ROC curves may be used to determine the impact of changing the ratio of training to testing data, varying the random selection of testing data, and/or of using training data for a same resource-providing entity in different time periods. A ROC AUC may also be used to evaluate the performance of a model over time.

Precision, or positive predictive value, may be used to answer the question of what proportion of predicted positives were actually correct.

Precision may be defined as:

$$Precision = \frac{number of true positives}{number of true positive + number of false positives} \qquad \underline{Equation 3}$$

A perfectly precise model produces no false positives and may have a precision of 1.

Recall may be used to answer the question of what proportion of actual positives were predicted correctly. Recall may also be referred to as sensitivity or true positive rate. Recall may be defined as:

$$Recall = \frac{number of true positives}{number of true positive + number of false negatives} \qquad \underline{Equation 4}$$

For example, a model with perfect recall produces no false negatives and has a recall of 1.

By plotting precision and recall at different discrimination thresholds the trade-off between precision and recall may be analyzed. Models with higher curves may generally have better performance. PR AUC may be used to compare predictive machine learning models mathematically.

The greater the PR AUC, the better the performance of a predictive machine learning model may be. The applications for a PR curve and AUC when developing, training, testing and monitoring a predictive machine learning model may be similar to that of an ROC Curve and ROC AUC. PR may be generally favored when data is imbalanced because neither precision nor recall takes into account the true negative value and so comparing two PR values versus two ROC values for data sets that are imbalanced, PR values may show a better distinction on relative performance.

Accuracy and F1-score may comprise additional methods of analyzing predictive machine learning model performance. Accuracy may represent total predictions that were correct out of all predictions from a predictive machine learning model. F1-score combines the precision and recall into a single score. The precision and recall metrics may be viewed as tradeoffs, therefore having a single score to look at an average of the two where they both have equal weight can be helpful. F1-score is useful when looking at imbalanced data and can be calculated as the harmonic mean (a metric used when looking to calculate an average rate) of precision and recall:

$$F 1 = 2 * \frac{Prec ision * Recall}{Precision + Recall} \qquad \underline{Equation 5}$$

A predictive machine learning model may obtain a high F1-score if both precision and recall are high. A predictive machine learning model may obtain a low F1-score if both precision and recall are low. A predictive machine learning model may obtain a medium F1-score if one of precision or recall is low and the other is high.

SHAP values may be used to understand the output of a predictive machine learning model by evaluating the importance of features the predictive machine learning model uses. SHAP values may be used to answer the question of how much each feature contributes to a final result of the predictive machine learning model to help identify what features were most important in deciding, for example, why did one resource-providing entity with low task performance volume have an 80% probability of responding outside of a target response time when other resource-providing entities with similar task performance volume typically have a 30% probability. A SHAP plot for a single observation may show the features that contribute to a final predicted value by their impact on the average model prediction, so their value may be positive or negative, but the absolute value may provide a measure of impact. Similar to Gini Impurity, SHAP values may also be used to rank features used in a predictive machine learning model by importance for an aggregate cohort.

Referring back to FIG. 5, in some embodiments, at step/operation 508, the computing system 101 determines a root cause of the decrease in performance based on one or more changes associated with the decrease in performance. In some embodiments, a root cause comprises a source of decreased performance of a predictive machine learning model. The root cause of the decrease in performance may be determined based on one or more changes associated with the decrease in performance, such as in a particular metric. A plurality of out-of-sample testing may be performed on a predictive machine learning model periodically to evaluate change in one or more performance metrics. In some embodiments, performing a plurality of out-of-sample testing comprises increasing a rolling sample window periodically as new data is available to update production data. As periodic out-of-sample testing is performed, one or more performance metrics may be evaluated for decrease in predictive machine learning model performance. Changes in one or more performance metrics resulting in decrease of predictive machine learning model performance may cause further analysis to determine a root cause and re-training of the predictive machine learning model based on the root cause. In some embodiments, determining a root cause comprises determining one or more differences between model inputs, such as production data, over time. In some embodiments, determining a root cause comprises generating a distribution of prediction outputs generated by a predictive machine learning model over time and determining changes in the prediction outputs over time based on the distribution.

In some embodiments, determining a root cause comprises determining one or more changes in one or more cohort metrics associated with resource-providing entities from production data and determining that the decrease in performance is associated with at least one of the one or more changes in the one or more cohort metrics. In some embodiments, a cohort metric describes a measurable characteristic of a resource-providing entity. Changes in one or more cohort metrics associated with resource-providing entities may be reflected in production data over time, and thus, may affect a predictive machine learning model's ability to generate accurate or effective predictions on the production data due to the predictive machine learning model's training based on older production data.

In some embodiments, at step/operation 510, the computing system 101 initiates one or more re-training operations for the predictive machine learning model with an updated training dataset based on the root cause. The updated training dataset may comprise feature values based on most up-to-date production data and simulation outcomes based on simulation outcome-affecting data extracted from the most up-to-date production data. In some embodiments, the one or more third features and the simulation outcomes of the updated training dataset are matched to a cohort metric associated with resource-providing entities from the most up-to-date production data. That is, features matching the cohort metric do not exist or are present in the most up-to-date production data, the one or more third features may be synthetically generated to match the cohort metric.

Various embodiments of the present disclosure comprise a computing system that is configured to predict a probability of an outcome associated with a simulation prediction object. For example, the simulation prediction object may be associated with a potential resource request. In an example embodiment, a computing system comprises a predictive machine learning model trained based on training data comprising observations of whether potential resource requests (e.g., training simulation prediction objects) may be responded to within a target response time or outside the target response time based on simulated responses (e.g., training simulation outcomes) based on prior task performance history (e.g., training simulation outcome-affecting data) extracted from at least a portion of production data. For example, the portion of production data may comprise a 60/40 split of a resource-providing entity population. In the same example embodiment or another example embodiment, the predictive machine learning model may be trained to predict resource request outcomes for a plurality of resource sizes and target response times based on the training data.

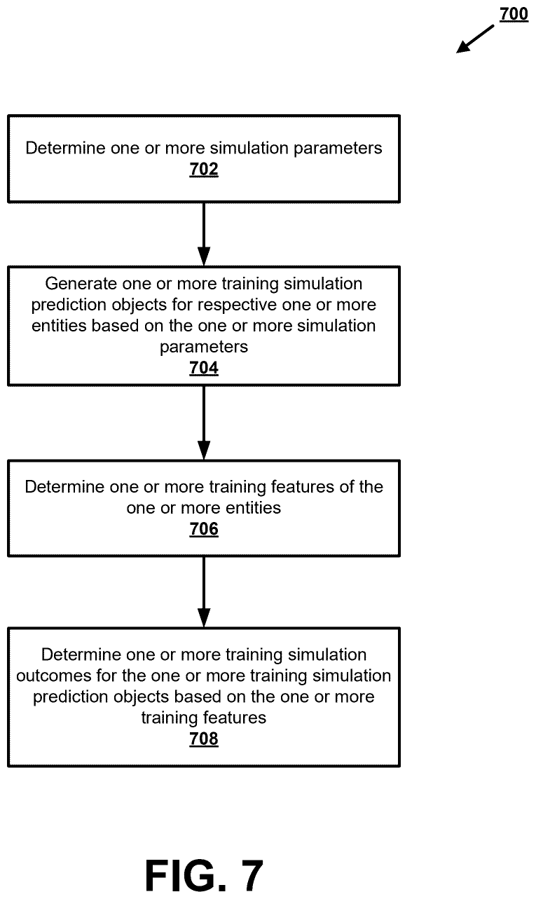

FIG. 7 is a flowchart diagram of an example process 700 for generating training data. FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 begins at step/operation 702 when the computing system 101 determines one or more simulation parameters. The one or more simulation parameters may be used to generate one or more training simulation prediction objects. For example, a training simulation prediction object may be representative of a potential resource request provided to a resource-providing entity and one or more simulation parameters, such as a resource request time, a resource size, and/or a target response time may be defined for the training simulation prediction object. In some embodiments, determining the one or more simulation parameters comprises varying any of the one or more parameters within given ranges for respective one or more training simulation prediction objects such that training data comprising a comprehensive combination of data patterns may be generated. In some embodiments, values of any one of the one or more parameters are determined randomly. For example, to avoid any bias, the computing system 101 may determine random resource request times for each resource-providing entity in a training set.

In some embodiments, at step/operation 704, the computing system 101 generates one or more training simulation prediction objects for respective one or more resource-providing entities based on the one or more simulation parameters. For example, one or more resource-providing entities may comprise one or more resource-providing entities from a cohort of resource-providing entities, and a given one of the one or more training simulation prediction objects generated may be representative of a potential resource request provided to a resource-providing entity of the cohort at a specific resource request time for a specific resource size, where a desirable outcome for the potential resource request comprises a specific target response time.

In some embodiments, at step/operation 706, the computing system 101 determines one or more training features of the one or more resource-providing entities. In some embodiments, the one or more simulation parameters are used as criteria for specifying or refining data from production data to determine the one or more training features. For example, for each resource-providing entity, at least one simulation parameter associated with a potential resource request provided to the resource-providing entity, e.g., resource request time, may be used as training features of the resource-providing entity. In a further example, the at least one simulation parameter comprising a resource request time may be used to determine one or more training features of the resource-providing entity from production data comprising task performance history. A potential resource request amount may be based on an expectation of future task performance, and future task performances may be theoretically used to determine a response of a potential resource request.

In some embodiments, at step/operation 708, the computing system 101 determines one or more training simulation outcomes for the one or more training simulation prediction objects based on the one or more training features. According to various embodiments of the present disclosure, the one or more training features comprise simulation outcome-affecting data which are used to determine respective one or more training simulation outcomes by simulating one or more training simulation prediction objects with the simulation outcome-affecting data. For example, a training simulation prediction object may be representative of a potential resource request to a resource-providing entity, and a training simulation outcome, comprising a simulation of a potential resource request and a simulated response to the potential resource request by the resource-providing entity, may be generated based on simulation outcome-affecting data comprising receipt of task performances (e.g., that may be used to respond to the simulated resource request) by the resource-providing entity.

Accordingly, a predictive machine learning model may be trained by observing training simulation outcomes of training simulation prediction object and associating training features with the training simulation outcomes. Based on such observations, a predictive machine learning model may generate prediction outputs for simulation prediction objects on one or more target resource-providing entities, e.g., making predictions on whether resource-providing entities, if requested a resource at a specific time period, will or will not respond to the resource request within a target response time.

In some embodiments, the predictive data analysis comprises a Random Forest machine learning model. For example, a Random Forest machine learning model may be trained to predict a probability that a resource request will be responded to within a target response time specific to a resource size. In some embodiments, the Random Forest machine learning model is used to evaluate one or more resource-providing entities (e.g., selected from a cohort) based on a risk score for a plurality of resource sizes. For each resource size, the Random Forest machine learning model may generate a probability that the resource request will be responded to within a target response time.

In some embodiments, a Random Forest machine learning model is trained by creating a collection of decision trees, optimizing the trees (e.g., via Gini Impurity), and examining different feature combinations from the collection of optimized trees to determine a decision (“class”), which avoids the level of overfitting that single decision trees tend to exhibit. For example, the result of training a Random Forest machine learning model may be the most optimized set of trees based on Gini Impurity. The set of optimized trees may then be used in a final Random Forest machine learning model version. In some embodiments, the output from a Random Forest machine learning model training comprises a final forest of decision trees that has the most predictive power of all the other combinations of decision trees evaluated during the training. A final prediction of the Random Forest machine learning model (e.g., probability a resource request will be responded to within the target response time) may comprise a proportion of votes from all the trees in the Random Forest for an outcome. For example, a predicted probability of 46% results from 46 of 100 trees predicting a resource request will be responded to within the target response time. In some embodiments, during the training of a Random Forest machine learning model, settings are specified, such as settings to determine how many trees should be part of the algorithm, how many levels a tree should have, and what percent of the feature set are to be captured in the random selection for any given tree.

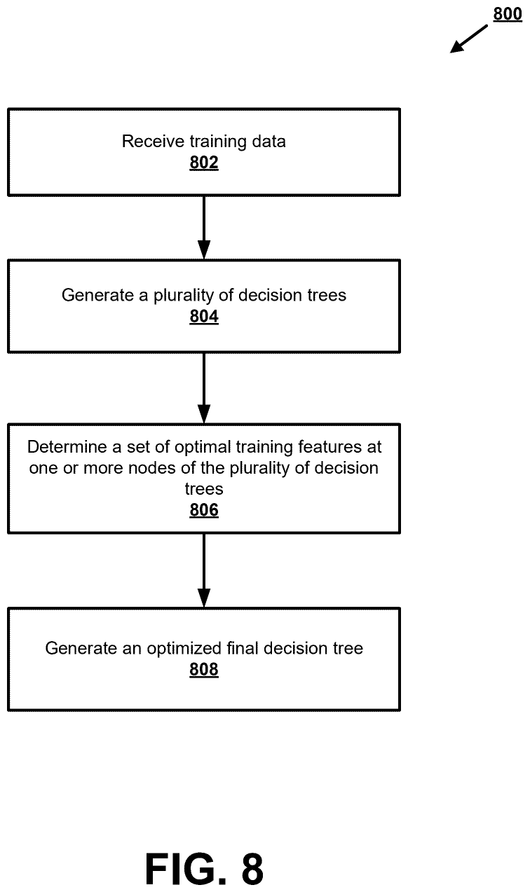

FIG. 8 is a flowchart diagram of an example process 800 for training a Random Forest machine learning model. FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 begins at step/operation 802 when the computing system 101 receives training data. In some embodiments, the training data comprises a plurality of training features associated with a plurality of resource-providing entities, a plurality of simulation prediction objects associated with respective ones of the plurality of resource-providing entities, and plurality of training simulation outcomes associated with respective ones of the plurality of simulation prediction objects. For example, training data may comprise features of a plurality of resource-providing entities and a simulation of whether each of the plurality resource-providing entities could respond to a potential resource request of one or more sizes within one or more target response times.

In some embodiments, at step/operation 804, the computing system 101 generates a plurality of decision trees based on the training data. The plurality of decision trees may comprise individual, uncorrelated decision trees, where a given one of the plurality of decision trees may comprise a unique subset of the training data. For example, each individual decision tree may be generated by randomly selecting certain training features from the training data. In an example embodiment, the plurality of decision trees may be generated based on training features.

A decision tree may comprise nodes associated with the training features and at each node a decision can be made by evaluating a feature value against a threshold. The evaluation may result in the split of the node either to additional nodes or to a leaf. The leaf may represent the end point where a classification decision is made. As such, a combination of features and thresholds associated with a decision tree may be recursively evaluated to determine the most efficient way to split the nodes to obtain a correct classification based on a portion of the training data associated with the decision tree. In one example embodiment, a plurality of nodes in a decision tree may be associated with a plurality of features associated with a resource-providing entity and a classification of whether a resource request will be responded to within the target response time or outside the target response time based on splitting of the nodes.

In some embodiments, at step/operation 806, the computing system 101 determines a set of optimal training features at one or more nodes of the plurality of decision trees. Determining the set optimal training features may comprise identifying a best feature/threshold combination at each node by minimizing Gini Impurity. In some embodiments, features that are of low importance based on Gini Impurity are removed on a basis that the low importance features provide no additional predictive power to the overall Random Forest machine learning model. Gini Impurity may comprise a measure of how often a randomly chosen observation from a set of observations (e.g., of training simulation outcomes) would be incorrectly classified if the observation was randomly classified using a feature/threshold combination. A feature/threshold combination with the lowest Gini Impurity may result in a lower probability of misclassification and therefore may be desirable to be used in a final decision tree. In other words, the Gini Impurity may be used to measure which features are the best at splitting the training data and thus have the most predictive power.

According to various embodiments of the present disclosure, Gini Impurity is calculated at each node of the plurality of decision trees. The Gini Impurity, G_{N}, for a given node can be summed up for each class k,

$${G}_{N} = {\sum }_{k = 1}^{c} {p}_{k} ( 1 - {p}_{k} ) \qquad \underline{Equation 6}$$

$${p}_{k} = \frac{N o . of observations with class k}{all observations in node} \qquad \underline{Equation 7}$$

where c may represent the number of classes (e.g., prediction outcomes) and pₖ may represent the probability of selecting a given class (e.g., prediction). For example, a plurality of decision trees comprising a Random Forest machine learning model may have two classes—response within the target response time, and response outside of the target response time.

In some embodiments, at step/operation 808, the computing system 101 generates an optimized final decision tree. The optimized final decision tree may comprise an average of the plurality of optimized decision trees, thus aggregating individual classification decisions from the plurality of optimized decision trees to produce a single result. Accordingly, the optimized final decision tree may be used to generate a final prediction representative of an average of classifications produced by the plurality of optimized decision trees.

In some embodiments, simulation outcomes for simulation prediction objects are used instead of actual outcomes for training and testing a prediction machine learning model.

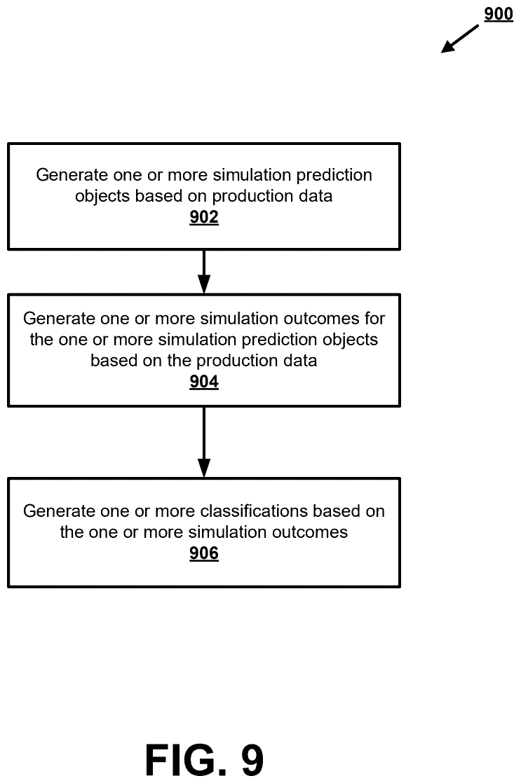

FIG. 9 is a flowchart diagram of an example process 900 for simulating simulation prediction objects. FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 begins at step/operation 902 when the computing system 101 generates one or more simulation prediction objects based on production data. Production data may comprise data collected, transformed, and provided as input to and/or used to train and/or test a predictive machine learning model. Furthermore, production data may comprise one or more features, associated with one or more resource-providing entities of a cohort, usable by a predictive machine learning model to learn and generate predictions on simulation prediction objects. The one or more simulation prediction objects may be simulated for respective one or more resource-providing entities and comprise one or more simulation parameters based on the production data. For example, the one or more simulation prediction objects may be representative of potential resource requests comprising simulation parameters, such as resource size, target response time, and/or response rate, which may be requested from one or more resource-providing entities. As a further example, the production data may comprise actual historic task performance data that may be used to determine the resource size (e.g., based on an assumption of future task performances (e.g., average based on history)) and target response times to the potential resource requests for each of the resource-providing entities.

In some embodiments, at step/operation 904, the computing system 101 generates one or more simulation outcomes for the one or more simulation prediction objects based on the production data. For example, a simulation outcome for a simulation prediction object representative of a resource request may comprise an performance of the resource and a simulation of actual response time to a resource request that is calculated based on historic task performance data (based on an extrapolation of the historic task performances data).

In some embodiments, at step/operation 906, the computing system 101 generates one or more classifications based on the one or more simulation outcomes. For example, if a simulation outcome comprises a response within a target response time of a resource request, a “True” or binary ‘1’ classification may be generated for the resource request. Conversely, if a simulation outcome comprises a response outside the target response time of the resource request, a “False” or binary ‘0’ classification may be generated for the resource request.

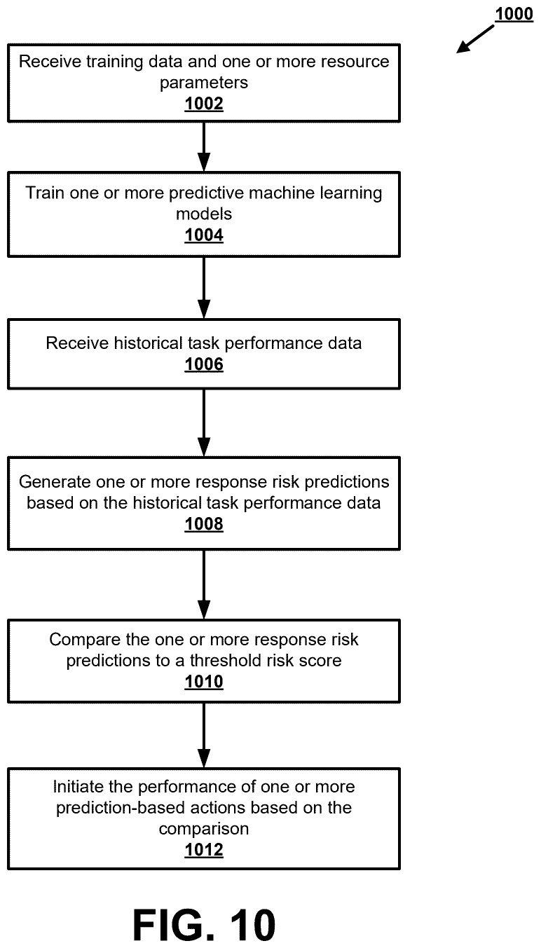

FIG. 10 is a flowchart diagram of an example process 1000 for performing resource requests. FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 begins at step/operation 1002 when the computing system 101 receives training data and one or more resource parameters for one or more resource types. In some embodiments, the training data comprises one or more simulations of potential resource requests and associated response outcomes of the potential resource requests based on the historical task performance data (e.g., training simulation outcomes of training simulation prediction objects). The one or more resource parameters may be used to characterize the training data, e.g., representing potential resource requests. In some embodiments, the one or more resource parameters comprises one or more of resource size (e.g., processing load and/or demand), resource request time, resource response duration, and/or target response time.

In some embodiments, at step/operation 1004, the computing system 101 trains one or more predictive machine learning models associated with respective ones of the one or more resource types based on the training data and the one or more resource parameters. According to various embodiments of the present disclosure, the one or more predictive machine learning models are trained to generate response risk predictions without requesting confidential information from a resource-providing entity. In so doing, the one or more predictive machine learning models may be trained to predict a resource-providing entity's risk without access to protected resource-providing entity information, such as confidential details that are traditionally privately held and subject to resource intensive security requirements. This, in turn, reduces the expenditure of computing resources traditionally necessary for safeguarding protected data, such as preprocessing of data to remove confidential information, while expanding the breadth of training data available for training, refining, and evaluating machine learning models. In this manner, some techniques of the present disclosure enable the generation and continuous maintenance of new predictive machine learning models with access to robust training datasets that may be maintained with limited computing resources compared to conventional models.

In some embodiments, the one or more predictive machine learning models comprise separate models that are each trained to output a risk prediction tailored to a particular resource structure and response mechanism. For example, each of the one or more predictive machine learning models may be trained to predict a probability that a resource request will be responded to within a target response time for a given resource size. In some embodiments, the one or more predictive machine learning models comprise one or more of Random Forest machine learning models, ensemble machine learning models, or other types of supervised machine learning models. In one example embodiment, one or more of Random Forest machine learning models comprises a final prediction (probability a resource request will be responded to within a target response time) that is a proportion of votes from all the trees in the Random Forest for an outcome (e.g., a predicted probability of 46% results from 46 of 100 trees predicting a resource request will be responded to within the target response time).

In some embodiments, the one or more predictive machine learning models are trained for a plurality of resource sizes with respect to an amount of task performances. In some embodiments, training the one or more predictive machine learning models further comprise training the one or more predictive machine learning models to generate, based on an amount of task performances, one or more response risk predictions for one or more resource requests comprising one or more resource sizes. The one or more predictive machine learning models may be trained on simulated resource requests over a historical period based on simulated response extrapolated based on actual historic task performances over the historical period of time. For example, such resource request simulation may be provided as training data to the one or more predictive machine learning models to classify for each resource-providing entity, and for each resource size, whether the simulated resource requests in a time period would have been responded to within a target response time for the resource size or not.

In some embodiments, at step/operation 1006, the computing system 101 receives historical task performance data associated with one or more resource-providing entities. The one or more resource-providing entities may be associated with resource-providing entities. In some embodiments, the historical task performance data comprises one or more feature associated with the one or more resource-providing entities that are used by the trained one or more predictive machine learning models to generate one or more response risk predictions.

In some embodiments, at step/operation 1008, the computing system 101 generates, using the one or more predictive machine learning models, one or more response risk predictions for the one or more resource types based on the historical task performance data. The one or more response risk predictions may comprise one or more probabilities of the one or more resource requests comprising the one or more resource types being responded to within a target response time by the one or more resource-providing entities. In some embodiments, a response risk prediction comprises a number between ‘0’ and ‘1’ with ‘1’ being the highest probability that the resource-providing entity will respond to the resource request within the target response time and ‘0’ being the lowest probability that a resource-providing entity will respond to the resource request within the target response time. For example, a resource-requesting entity may define a range of response risk prediction values that are acceptable to be considered low risk (highest probability that the resource-providing entity will respond to the resource request).

In some embodiments, the one or more predictive machine learning models are used to evaluate resource-providing entities by making response risk predictions on whether each resource-providing entity, if requested a resource in a specific time period, will or will not respond to the resource request within its target response time. Accordingly, the one or more predictive machine learning models may predict resource-providing entities that will respond within a target response time, which allows the output of the one or more predictive machine learning models to be used effectively to select low risk resource-providing entities to target for requesting resources. Moreover, as described herein, the ability to respond to a resource request may be tracked through task performance data associated with a low risk resource-providing entity and insights from the participation may be leverage to further refine one or more machine learning models tailored to a specific resource request.

In some embodiments, at step/operation 1010, the computing system 101 compares the one or more response risk predictions to a threshold risk score. The one or more response risk predictions may be used by, for example, a resource-requesting entity for performing resource requests according to guidelines specified by a resource-requesting entity. In some embodiments, eligibility of the one or more resource-providing entities for the one or more resource requests are determined based on the comparison. In some embodiments, a threshold risk score is dynamically varied by the resource-requesting entity.

The threshold risk score may comprise a logic condition associated with a target outcome of the one or more response risk predictions. For example, the target outcome may comprise response of a resource request within a target response time. In some embodiments, the threshold risk score is associated with a value in which a response risk prediction generated by the one or more predictive machine learning models is labeled as ‘true’ (e.g., a prediction that the resource request will be responded to within the target response time). A response risk prediction equal to or above the threshold risk score may be categorized as ‘true.’ For example, a predictive machine learning model response risk prediction of 0.4 may be considered ‘false’ if the threshold risk score is 0.5, but would be considered ‘true’ if the threshold risk score is 0.3. Accordingly, a list of low-risk resource-providing entities per resource size that are considered suitable for a resource request may be generated.

In some embodiments, at step/operation 1012, the computing system 101 initiates the performance of one or more prediction-based actions based on the comparison. In some embodiments, initiating the performance of one or more prediction-based actions further comprises requesting, from one or more resource-providing entities, one or more resources with the one or more resource parameters based on the comparison. In some embodiments, initiating the performance of the one or more prediction-based actions based on the comparison comprises, for example, performing a resource-based action (e.g., allocation of resource), generating an analytical report, generating and/or executing action scripts, generating alerts or messages, or generating one or more electronic communications. The one or more prediction-based actions may further include displaying visual renderings of the aforementioned examples of prediction-based actions in addition to values, charts, and representations associated with the comparison and/or the one or more response risk predictions using a prediction output user interface.

Accordingly, as described above, various embodiments of the present disclosure make important technical contributions to improving predictive accuracy of predictive machine learning models by determining decreases in performance of a predictive machine learning model over time and adapting the predictive machine learning model based on a root cause of the decrease in performance. This approach prevents predictive machine learning model degradation and improves re-training efficiency of predictive machine learning models. It is well-understood in the relevant art that the performance of a predictive machine learning model decreases over time due to training using historical data, and as such, a predictive machine learning model performs best when the historical data patterns it is trained on are similar to current time period data patterns. Thus, the challenge is to improve maintaining a certain level of predictive machine learning model performance over time as new patterns emerge in input data without sacrificing the number of computational operations needed and/or the amount of training data entries needed to train predictive machine learning models. Accordingly, techniques that improve predictive accuracy by re-training on an as-needed basis, such as the techniques described herein, enable improving re-training efficiency given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

Some techniques of the present disclosure enable the generation of prediction outputs that may be performed to initiate one or more predictive actions to achieve real-world effects. The predictive operations of the present disclosure may be used, applied, and/or otherwise leveraged to generate a predictive machine learning model, which may help in predicting outcomes for simulation prediction objects. The predictive machine learning model of the present disclosure may be leveraged to initiate the performance of various computing tasks that improve the performance of a computing system (e.g., a computer itself, etc.) with respect to various predictive actions performed by the computing system, such as for the prediction of outcomes for simulation prediction objects, and/or the like. Example predictive actions may include the generation of an abstractive summary to summarize prediction probabilities of outcomes and prediction action to automatically act on the prediction probabilities. For instance, the abstractive summary may be interpreted to determine a predictive action for a predicted outcome and automatically initiating an action output.

In some examples, the computing tasks may include predictive actions that may be based on a prediction domain. A prediction domain may include any environment in which computing systems may be applied to achieve real-word insights, such as predictions (e.g., abstractive summaries, predictive intents, etc.), and initiate the performance of computing tasks, such as predictive actions e.g., updating user preferences, providing account information, cancelling an account, adding an account, etc.) to act on the real-world insights. These predictive actions may cause real-world changes, for example, by controlling a hardware component, providing alerts, interactive actions, and/or the like.

Examples of prediction domains may include confidential systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

In some embodiments, the predictive operations of process 400 are applied to initiate the performance of one or more predictive actions. A predictive action may depend on the prediction domain. In some examples, the computing 101 may leverage the predictive operations to generate a machine learning model that may be leveraged to initiate the prediction of outcomes for simulation prediction objects, and/or any other operations for predicting outcomes for simulated conditions.

### V. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method comprising: determining, by one or more processors, one or more in-sample performance metrics for a predictive machine learning model based on an in-sample test on the predictive machine learning model using one or more first test simulation prediction objects associated with first production data during a first time period; determining, by the one or more processors, one or more out-of-sample performance metrics for the predictive machine learning model based on one or more out-of-sample tests on the predictive machine learning model using one or more second test simulation prediction objects associated with second production data during a second time period subsequent to the first time period; determining, by the one or more processors, a decrease in performance of the predictive machine learning model based on a comparison between the one or more in-sample performance metrics and the one or more out-of-sample performance metrics; determining, by the one or more processors, a root cause of the decrease in performance based on one or more changes associated with the decrease in performance; and initiating, by the one or more processors, one or more re-training operations for the predictive machine learning model with an updated training dataset based on the root cause.

Example 2. The computer-implemented method of example 1, wherein the predictive machine learning model comprises a Random Forest machine learning model.

Example 3. The computer-implemented method of examples 1 or 2, wherein the one or more out-of-sample performance metrics or the one or more in-sample performance metrics comprise at least one of confusion matrix, receiver operator characteristic curve, precision, recall, precision/recall curve, accuracy, F1-score, or Shapley Additive Explanation values.

Example 4. The computer-implemented method of any of the preceding examples, wherein the in-sample test comprises: generating the one or more first test simulation prediction objects for one or more entities during the first time period; determining one or more first feature values based on the first production data; generating, using the predictive machine learning model, one or more first prediction outputs for the one or more first test simulation prediction objects based on the one or more first feature values; extracting first simulation outcome-affecting data from the first production data; generating a first set of test simulation outcomes associated with the one or more first test simulation prediction objects based on the first simulation outcome-affecting data; and determining the one or more in-sample performance metrics based on a comparison between a determination of whether the first set of test simulation outcomes comprises a target outcome for the one or more first test simulation prediction objects and the one or more first prediction outputs.

Example 5. The computer-implemented method of example 4, wherein the one or more out-of-sample tests comprise generating the one or more second test simulation prediction objects for the one or more entities during the second time period; determining one or more second feature values based on a second production data during the second time period; generating, using the predictive machine learning model, one or more second prediction outputs for the one or more second test simulation prediction objects based on the one or more second feature values; extracting second simulation outcome-affecting data from the second production data; generating a second set of test simulation outcomes associated with the one or more second test simulation prediction objects based on the second simulation outcome-affecting data; and determining the one or more out-of-sample performance metrics based on a comparison between whether the second set of test simulation outcomes comprises the target outcome for the one or more second test simulation prediction objects to the one or more second prediction outputs.

Example 6. The computer-implemented method of example 5, wherein the updated training dataset comprises (i) one or more third feature values based on third production data during a third time period and (ii) a third set of simulation outcomes based on third simulation outcome-affecting data extracted from the third production data.

Example 7. The computer-implemented method of any of the preceding examples further comprising determining a change between the one or more first prediction outputs and the one or more second prediction outputs based on a comparison between the one or more first prediction outputs and the one or more second prediction outputs, wherein (i) the one or more first prediction outputs are generated by the predictive machine learning model trained on a prior training dataset and (ii) the one or more second prediction outputs are generated by the predictive machine learning model re-trained with the updated training dataset.

Example 8. The computer-implemented method of any of the preceding examples, wherein determining the root cause comprises: determining one or more changes in one or more cohort metrics associated with one or more entities; and determining that the decrease in performance is associated with at least one of the one or more changes in the one or more cohort metrics.

Example 9. The computer-implemented method of any of the preceding examples, wherein determining the root cause comprises: determining one or more differences between a current production data and a prior training dataset.

Example 10. The computer-implemented method of any of the preceding examples, wherein the predictive machine learning model is trained on training data comprising (i) one or more features associated with respective one or more entities during the first time period and (ii) one or more training simulation outcomes associated with respective one or more training simulation prediction objects, wherein (a) the one or more features comprise simulation outcome-affecting data and (b) the one or more training simulation outcomes are based on the simulation outcome-affecting data.

Example 11. The computer-implemented method of any of the preceding examples, wherein the second time period comprises a rolling sample window based on availability of new production data.

Example 12. A computing system comprising memory and one or more processors communicatively coupled to the memory, the one or more processors configured to: determine one or more in-sample performance metrics for a predictive machine learning model based on an in-sample test on the predictive machine learning model using one or more first test simulation prediction objects associated with first production data during a first time period; determine one or more out-of-sample performance metrics for the predictive machine learning model based on one or more out-of-sample tests on the predictive machine learning model using one or more second test simulation prediction objects associated with second production data during a second time period subsequent to the first time period; determine a decrease in performance of the predictive machine learning model based on a comparison between the one or more in-sample performance metrics and the one or more out-of-sample performance metrics; determine a root cause of the decrease in performance based on one or more changes associated with the decrease in performance; and initiate one or more re-training operations for the predictive machine learning model with an updated training dataset based on the root cause.

Example 13. The computing system of example 12, wherein the one or more out-of-sample performance metrics or the one or more in-sample performance metrics comprise at least one of confusion matrix, receiver operator characteristic curve, precision, recall, precision/recall curve, accuracy, F1-score, or Shapley Additive Explanation values.

Example 14. The computing system of examples 12 or 13, wherein the one or more processors are further configured to: generate the one or more first test simulation prediction objects for one or more entities during the first time period; determine one or more first feature values based on the first production data; generate, using the predictive machine learning model, one or more first prediction outputs for the one or more first test simulation prediction objects based on the one or more first feature values; extract first simulation outcome-affecting data from the first production data; generate a first set of test simulation outcomes associated with the one or more first test simulation prediction objects based on the first simulation outcome-affecting data; and determine the one or more in-sample performance metrics based on a comparison between a determination of whether the first set of test simulation outcomes comprises a target outcome for the one or more first test simulation prediction objects and the one or more first prediction outputs.

Example 15. The computing system of example 14, wherein the one or more processors are further configured to: generate the one or more second test simulation prediction objects for the one or more entities during the second time period; determine one or more second feature values based on the second production data during the second time period; generate, using the predictive machine learning model, one or more second prediction outputs for the one or more second test simulation prediction objects based on the one or more second feature values; extract second simulation outcome-affecting data from the second production data; generate a second set of test simulation outcomes associated with the one or more second test simulation prediction objects based on the second simulation outcome-affecting data; and determine the one or more out-of-sample performance metrics based on a comparison between whether the second set of test simulation outcomes comprises the target outcome for the one or more second test simulation prediction objects to the one or more second prediction outputs.

Example 16. The computing system of example 15, wherein the updated training dataset comprises (i) one or more third feature values based on third production data during a third time period and (ii) a third set of simulation outcomes based on third simulation outcome-affecting data extracted from the third production data.

Example 17. The computing system of example 15, wherein the one or more processors are further configured to: determining a change between the one or more first prediction outputs and the one or more second prediction outputs based on a comparison between the one or more first prediction outputs and the one or more second prediction outputs, wherein (i) the one or more first prediction outputs are generated by the predictive machine learning model trained on a prior training dataset and (ii) the one or more second prediction outputs are generated by the predictive machine learning model re-trained with the updated training dataset.

Example 18. The computing system of examples 12 through 17, wherein the one or more processors are further configured to: determine one or more changes in one or more cohort metrics associated with one or more entities; and determine that the decrease in performance is associated with at least one of the one or more changes in the one or more cohort metrics.

Example 19. The computing system of examples 12 through 18, wherein the one or more processors are further configured to: determine one or more differences between a current production data and a prior training dataset.

Example 20. One or more non-transitory computer-readable storage media including instructions that, when executed by one or more processors, cause the one or more processors to: determine one or more in-sample performance metrics for a predictive machine learning model based on an in-sample test on the predictive machine learning model using one or more first test simulation prediction objects associated with first production data during a first time period; determine one or more out-of-sample performance metrics for the predictive machine learning model based on one or more out-of-sample tests on the predictive machine learning model using one or more second test simulation prediction objects associated with second production data during a second time period subsequent to the first time period; determine a decrease in performance of the predictive machine learning model based on a comparison between the one or more in-sample performance metrics and the one or more out-of-sample performance metrics; determine a root cause of the decrease in performance based on one or more changes associated with the decrease in performance; and initiate one or more re-training operations for the predictive machine learning model with an updated training dataset based on the root cause.

Example 21. The computer implemented method of example 1, wherein the predictive machine learning model comprises a Random Forest machine learning model and wherein initiating the one or more re-training operations comprises training the predictive machine learning model to generate one or more third prediction outputs.

Example 22. The computer implemented method of example 21, wherein the one or more re-training operations are performed by the one or more processors.

Example 23. The computer implemented method of example 21, wherein the one or more processors are included in a first computing entity; and the one or more re-training operations are performed by one or more other processors included in a second computing entity.

Example 24. The computer implemented method of example 1, wherein the one or more processors are included in a first computing entity; and one or more other processors included in a second computing entity are configured to generate one or more third prediction outputs.

Example 25. The computing system of example 12, wherein the predictive machine learning model comprises a Random Forest machine learning model and wherein initiating the one or more re-training operations comprises training the predictive machine learning model to generate one or more third prediction outputs.

Example 26. The computing system of example 25, wherein the one or more re-training operations are performed by the one or more processors.

Example 27. The computing system of example 25, wherein the one or more processors are included in a first computing entity; and the one or more re-training operations are performed by one or more other processors included in a second computing entity.

Example 28. The computing system of example 12, wherein the one or more processors are included in a first computing entity; and one or more other processors included in a second computing entity are configured to generate one or more third prediction outputs.

Example 29. The one or more non-transitory computer-readable storage media of example 20, wherein the predictive machine learning model comprises a Random Forest machine learning model and wherein initiating the one or more re-training operations comprises training the predictive machine learning model to generate one or more third prediction outputs.

Example 30. The one or more non-transitory computer-readable storage media of example 29, wherein the one or more re-training operations are performed by the one or more processors.

Example 31. The one or more non-transitory computer-readable storage media of example 29, wherein the one or more processors are included in a first computing entity; and the one or more re-training operations are performed by one or more other processors included in a second computing entity.

Example 32. The one or more non-transitory computer-readable storage media of example 20, wherein the one or more processors are included in a first computing entity; and one or more other processors included in a second computing entity are configured to generate one or more third prediction outputs.

1. A computer-implemented method comprising:
determining, by one or more processors, one or more in-sample performance metrics for a predictive machine learning model based on an in-sample test on the predictive machine learning model using one or more first test simulation prediction objects associated with first production data during a first time period;
determining, by the one or more processors, one or more out-of-sample performance metrics for the predictive machine learning model based on one or more out-of-sample tests on the predictive machine learning model using one or more second test simulation prediction objects associated with second production data during a second time period subsequent to the first time period;
determining, by the one or more processors, a decrease in performance of the predictive machine learning model based on a comparison between the one or more in-sample performance metrics and the one or more out-of-sample performance metrics;
determining, by the one or more processors, a root cause of the decrease in performance based on one or more changes associated with the decrease in performance; and
initiating, by the one or more processors, one or more re-training operations for the predictive machine learning model with an updated training dataset based on the root cause.

2. The computer-implemented method of claim 1, wherein the predictive machine learning model comprises a Random Forest machine learning model.

3. The computer-implemented method of claim 1, wherein the one or more out-of-sample performance metrics or the one or more in-sample performance metrics comprise at least one of confusion matrix, receiver operator characteristic curve, precision, recall, precision/recall curve, accuracy, F1-score, or Shapley Additive Explanation values.

4. The computer-implemented method of claim 1, wherein the in-sample test comprises:
generating the one or more first test simulation prediction objects for one or more entities during the first time period;
determining one or more first feature values based on the first production data;
generating, using the predictive machine learning model, one or more first prediction outputs for the one or more first test simulation prediction objects based on the one or more first feature values;
extracting first simulation outcome-affecting data from the first production data;
generating a first set of test simulation outcomes associated with the one or more first test simulation prediction objects based on the first simulation outcome-affecting data; and
determining the one or more in-sample performance metrics based on a comparison between a determination of whether the first set of test simulation outcomes comprises a target outcome for the one or more first test simulation prediction objects and the one or more first prediction outputs.

5. The computer-implemented method of claim 4, wherein the one or more out-of-sample tests comprise:
generating the one or more second test simulation prediction objects for the one or more entities during the second time period;
determining one or more second feature values based on a second production data during the second time period;
generating, using the predictive machine learning model, one or more second prediction outputs for the one or more second test simulation prediction objects based on the one or more second feature values;
extracting second simulation outcome-affecting data from the second production data;
generating a second set of test simulation outcomes associated with the one or more second test simulation prediction objects based on the second simulation outcome-affecting data; and
determining the one or more out-of-sample performance metrics based on a comparison between whether the second set of test simulation outcomes comprises the target outcome for the one or more second test simulation prediction objects to the one or more second prediction outputs.

6. The computer-implemented method of claim 5, wherein the updated training dataset comprises (i) one or more third feature values based on third production data during a third time period and (ii) a third set of simulation outcomes based on third simulation outcome-affecting data extracted from the third production data.

7. The computer-implemented method of claim 5 further comprising:
determining a change between the one or more first prediction outputs and the one or more second prediction outputs based on a comparison between the one or more first prediction outputs and the one or more second prediction outputs, wherein (i) the one or more first prediction outputs are generated by the predictive machine learning model trained on a prior training dataset and (ii) the one or more second prediction outputs are generated by the predictive machine learning model re-trained with the updated training dataset.

8. The computer-implemented method of claim 1, wherein determining the root cause comprises:
determining one or more changes in one or more cohort metrics associated with one or more entities; and
determining that the decrease in performance is associated with at least one of the one or more changes in the one or more cohort metrics.

9. The computer-implemented method of claim 1, wherein determining the root cause comprises:
determining one or more differences between a current production data and a prior training dataset.

10. The computer-implemented method of claim 1, wherein the predictive machine learning model is trained on training data comprising (i) one or more features associated with respective one or more entities during the first time period and (ii) one or more training simulation outcomes associated with respective one or more training simulation prediction objects, wherein (a) the one or more features comprise simulation outcome-affecting data and (b) the one or more training simulation outcomes are based on the simulation outcome-affecting data.

11. The computer-implemented method of claim 1, wherein the second time period comprises a rolling sample window based on availability of new production data.

12. A system comprising
one or more processors and
at least one memory storing processor-executable instructions that, when executed by any of the one or more processors, causes the one or more processors to perform operations comprising:
determining one or more in-sample performance metrics for a predictive machine learning model based on an in-sample test on the predictive machine learning model using one or more first test simulation prediction objects associated with first production data during a first time period;
determining one or more out-of-sample performance metrics for the predictive machine learning model based on one or more out-of-sample tests on the predictive machine learning model using one or more second test simulation prediction objects associated with second production data during a second time period subsequent to the first time period;
determining a decrease in performance of the predictive machine learning model based on a comparison between the one or more in-sample performance metrics and the one or more out-of-sample performance metrics;
determining a root cause of the decrease in performance based on one or more changes associated with the decrease in performance; and
initiating one or more re-training operations for the predictive machine learning model with an updated training dataset based on the root cause.

13. The system of claim 12, wherein the one or more out-of-sample performance metrics or the one or more in-sample performance metrics comprise at least one of confusion matrix, receiver operator characteristic curve, precision, recall, precision/recall curve, accuracy, F1-score, or Shapley Additive Explanation values.

14. The system of claim 12, wherein the operations further comprise:
generating the one or more first test simulation prediction objects for one or more entities during the first time period;
determining one or more first feature values based on the first production data;
generating, using the predictive machine learning model, one or more first prediction outputs for the one or more first test simulation prediction objects based on the one or more first feature values;
extracting first simulation outcome-affecting data from the first production data;
generating a first set of test simulation outcomes associated with the one or more first test simulation prediction objects based on the first simulation outcome-affecting data; and
determining the one or more in-sample performance metrics based on a comparison between a determination of whether the first set of test simulation outcomes comprises a target outcome for the one or more first test simulation prediction objects and the one or more first prediction outputs.

15. The system of claim 14, wherein the operations further comprise:
generating the one or more second test simulation prediction objects for the one or more entities during the second time period;
determining one or more second feature values based on the second production data during the second time period;
generating, using the predictive machine learning model, one or more second prediction outputs for the one or more second test simulation prediction objects based on the one or more second feature values;
extracting second simulation outcome-affecting data from the second production data;
generating a second set of test simulation outcomes associated with the one or more second test simulation prediction objects based on the second simulation outcome-affecting data; and
determining the one or more out-of-sample performance metrics based on a comparison between whether the second set of test simulation outcomes comprises the target outcome for the one or more second test simulation prediction objects to the one or more second prediction outputs.

16. The system of claim 15, wherein the updated training dataset comprises (i) one or more third feature values based on third production data during a third time period and (ii) a third set of simulation outcomes based on third simulation outcome-affecting data extracted from the third production data.

17. The system of claim 15, wherein the operations further comprise:
determining a change between the one or more first prediction outputs and the one or more second prediction outputs based on a comparison between the one or more first prediction outputs and the one or more second prediction outputs, wherein (i) the one or more first prediction outputs are generated by the predictive machine learning model trained on a prior training dataset and (ii) the one or more second prediction outputs are generated by the predictive machine learning model re-trained with the updated training dataset.

18. The system of claim 12, wherein the operations further comprise:
determining one or more changes in one or more cohort metrics associated with one or more entities; and
determining that the decrease in performance is associated with at least one of the one or more changes in the one or more cohort metrics.

19. The system of claim 12, wherein the operations further comprise:
determining one or more differences between a current production data and a prior training dataset.

20. One or more non-transitory computer-readable storage media including instructions that, when executed by one or more processors, cause the one or more processors to perform operations comprising:
determining one or more in-sample performance metrics for a predictive machine learning model based on an in-sample test on the predictive machine learning model using one or more first test simulation prediction objects associated with first production data during a first time period;
determining one or more out-of-sample performance metrics for the predictive machine learning model based on one or more out-of-sample tests on the predictive machine learning model using one or more second test simulation prediction objects associated with second production data during a second time period subsequent to the first time period;
determining a decrease in performance of the predictive machine learning model based on a comparison between the one or more in-sample performance metrics and the one or more out-of-sample performance metrics;
determining a root cause of the decrease in performance based on one or more changes associated with the decrease in performance; and
initiating one or more re-training operations for the predictive machine learning model with an updated training dataset based on the root cause.
